(19) United States
(12) Patent Application Publication
(10) Pub. No.: US 2012/0076625 A1
(43) Pub. Date: Mar. 29, 2012

(54) RHINESTONE PLACEMENT DEVICE

(75) Inventors: Frank Schimicci, Lake Stevens, WA (US); Tyler Panteleeff, Shoreline, WA (US); Christopher Stone, Everett, WA (US); Jacob Zeimantz, Seattle, WA (US); Robert J. Stockman, Seattle, WA (US); Kevin Reed, Woodinville, WA (US); Richard Fine, Mercer Island, WA (US); Karen Morris-Fine, Mercer Island, WA (US)

(73) Assignee: IOLINE CORPORATION, Woodinville, WA (US)

(21) Appl. No.: 12/892,910

(22) Filed: Sep. 28, 2010

(51) Int. Cl. B25J 15/06; B25J 11/00

(52) U.S. Cl. 414/589; 294/189; 414/800

(57) ABSTRACT

A rhinestone placement system and method provides a moving pickup head with self-contained vacuum supply for vacuum assisted pickup of rhinestones. The pickup head includes an adhesive property gasket portion that in cooperation with the vacuum supply temporarily holds a rhinestone for movement to a placement position.

### BACKGROUND OF THE INVENTION

This invention relates to application of decorative themes to articles, and more particularly to a system and method for placement of decorative rhinestones or the like on article.

Decorating items such as clothing, sun glasses, hats and hand bags with patterned rhinestones is popular to commemorate events and holidays. Rhinestone can be manually applied to items, but this requires some amount of time and can be tedious work that is difficult to replicate and has high labor cost. Pre-made motifs can be purchased, provided as heat transfer sheets having rhinestones in patterns thereon, applied to items by a heat press on the particular article at a point of sale. However, it is necessary to have the pre-made design transfer sheets on hand in advance, and customized designs typically require a minimum volume of purchase and advance ordering. The machines to produce the pre-made motifs are typically industrial type and are expensive and require, for example, significant operational space and/or external vacuum or compressors for operation. Also, pre-made motifs also do not provide the customized designs that are often desired.

Ioline, Inc. of Woodinville, Wash., introduced in 2009 a rhinestone placement device adapted for computer control to allow customized design production. The device is sized for desktop placement and operates much as a printer, translating a transfer head between rhinestone pickup locations and a transfer sheet, for placement of rhinestones in locations on the transfer sheet in accordance with a design pattern. The existing device, the CrystalPress™ automatic rhinestone placement machine, employs a rhinestone pickup tool with an adhesive pickup tool that is moved between pickup and placement locations.

### SUMMARY OF THE INVENTION

In accordance with the invention, improved pickup systems and methods are provided for an automated rhinestone placement device, wherein a vacuum assisted pickup device is provided, with the vacuum source provided on the moving pickup system.

Accordingly, it is an object of the present disclosed system and method to provide an improved rhinestone placement system and method.

It is a further object of the present disclosed system and method to provide an improved accuracy rhinestone pickup system and method in a rhinestone placement device.

It is yet another object of the present disclosed device to provide an improved automated rhinestone pickup system and method employing a vacuum assisted pickup tool with vacuum supply on the moving pickup head.

The subject matter of the present system and method is particularly pointed out and distinctly claimed in the concluding portion of this specification. However, both the organization and method of operation, together with further advantages and objects thereof, may best be understood by reference to the following description taken in connection with accompanying drawings wherein like reference characters refer to like elements.

### BRIEF DESCRIPTION OF THE DRAWINGS

FIG. 1 is a perspective view of a rhinestone placement device;

FIG. 2 is a top perspective view of the sorter bowl with wheel and rhinestones installed therein;

FIG. 3 is a top perspective view of the sorter bowl with the wiper assembly in an open position; wheel and rhinestones installed therein;

FIG. 4 is a perspective view of the pickup head assembly carrying the pickup tool and mounting and vacuum supply;

FIG. 5 is a perspective view of the pickup tool;

FIG. 6 is a side sectional view of the pickup tool taken along line 6-6 of FIG. 5, illustrating the configuration thereof;

FIG. 7 is a side sectional view of the pickup tool in position above sorter wheel preparatory to picking a rhinestone;

FIG. 8 is a flowchart of the pickup process steps;

FIGS. 9 and 10 are front and side perpsective views of the wiper assembly;

FIG. 11 is a sectional view showing the operation of the wiper to remove a mis-positioned rhinestone in the sorter wheel;

FIGS. 12 and 13 are front and rear views of an exemplary sorter wheel;

FIGS. 14-16 are perspective views of the pickup head assembly tool mounting, illustrating the steps of installing or replacing the tool to the head assembly; and

FIG. 17 is a block diagram of the operational system for the rhinestone placement device.

### DETAILED DESCRIPTION

The system according to a preferred embodiment comprises a rhinestone ‘printer’ device that picks rhinestones from a supply and places them on a transfer sheet in accordance with a stored design.

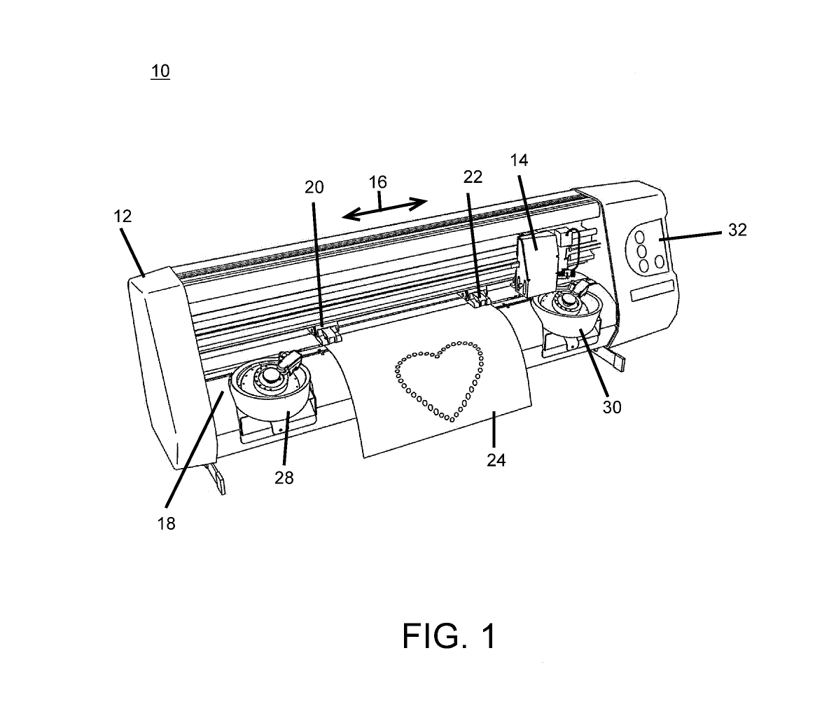

Referring to FIG. 1, a perspective view of a rhinestone placement device 10 comprises a chassis 12 carrying a movable placement head 14 adapted to be traverse along a Y-axis 16 over a platen 18 by operation of guide rails and belt drive mechanism (for example). Left and right pinch wheels 20, 22 are adapted to engage a transfer sheet 24 at a top surface thereof for ensuring driving engagement of the transfer sheet with drive wheels (not visible in FIG. 1) below the pinch wheels, such that operation of the drive wheels by rotation of a drive shaft carrying the drive wheels results in translation of the transfer sheet along the X-axis 26 across the platen over a transfer sheet travel path that allows the transfer sheet to pass unimpeded through the device from front to back. In operation, the transfer sheet is loaded from the front of the device and translated back and forth on axis 26 during rhinestone placement, ultimately being discharged at the front when the rhinestone placement operation is completed.

Left and right sorter bowls 28 and 30 are stationed at positions to the left and right of the pinch wheels, and receive and hold rhinestones for retrieval and delivery to the transfer sheet for placement thereon.

A control panel 32 is provided with operational keys and indicators for user control of functions of the device such as reset, manual feed of the transfer sheet, reset, status indicator, etc.

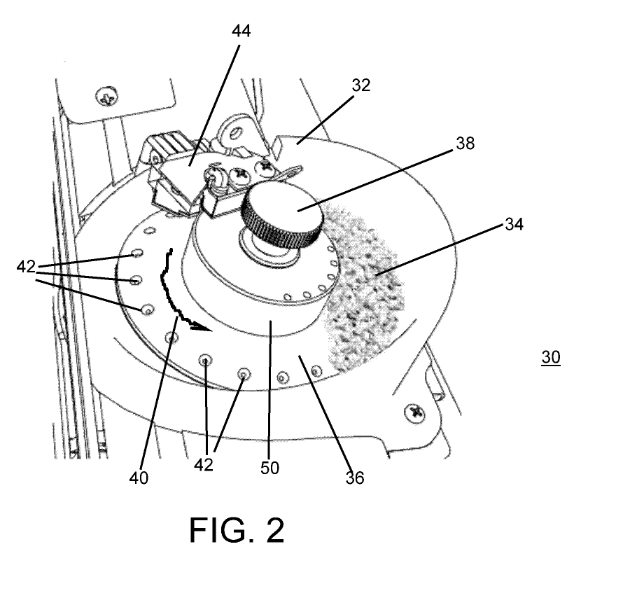

Referring now to FIG. 2, a top perspective view of a sorter bowl with wheel and rhinestones installed therein (in this case, right sorter bowl 30, left sorter bowl 28 would be of a corresponding configuration), bowl 30 is mounted to the chassis such that the top lip 32 of the bowl is tilted away from the body of the device at an angle sufficient to horizontally align the crystal with the pick-up tool. Suitable angles in particular embodiments are in a range of 10-30 degrees tilt, 22.5 degrees in the illustrated embodiment, but other angles may be employed as appropriate with modifications of other components in the pickup system. With the tilt, rhinestones 34 placed in the bowl will collect toward the lower side of the bowl by operation of gravity. A sorter wheel 36 is received in the bowl and defines a substantial portion of the bottom of the bowl so that the rhinestone rest on a portion of the sorter wheel. The wheel is rotationally engaged by a drive shaft, removably secured thereto by threaded engagement of sorter wheel knob 38 and the drive shaft and such that the wheel rotates in a counter clockwise direction 40. Plural rhinestone receiving holes 42 are defined about the periphery of the wheel such that as the wheel rotates, rhinestones will seat in the holes for individual retrieval and placement to the transfer sheet as discussed below.

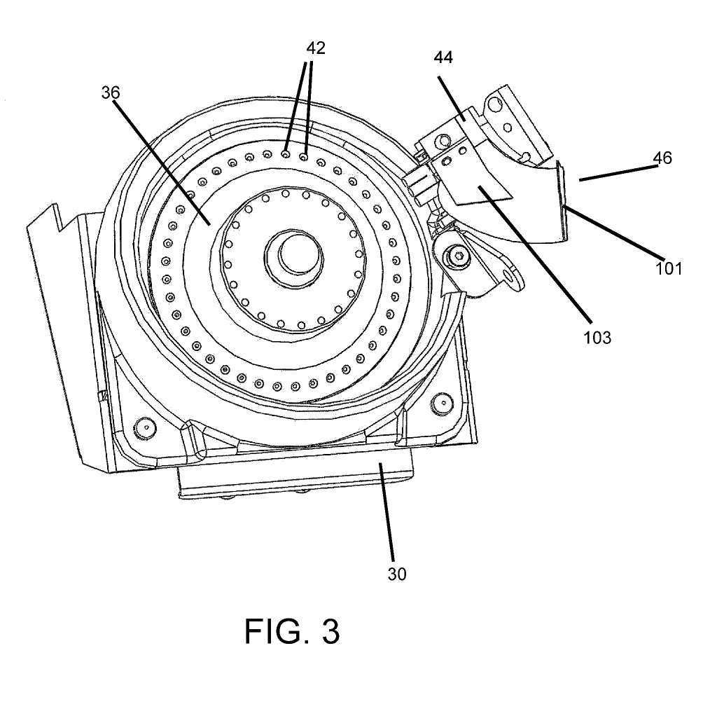

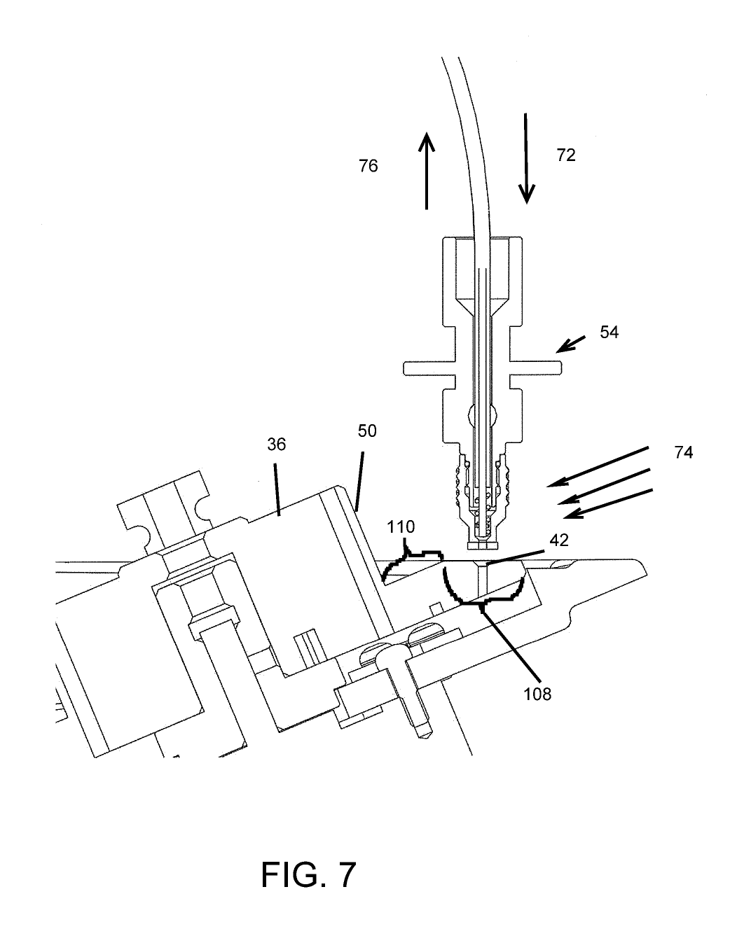

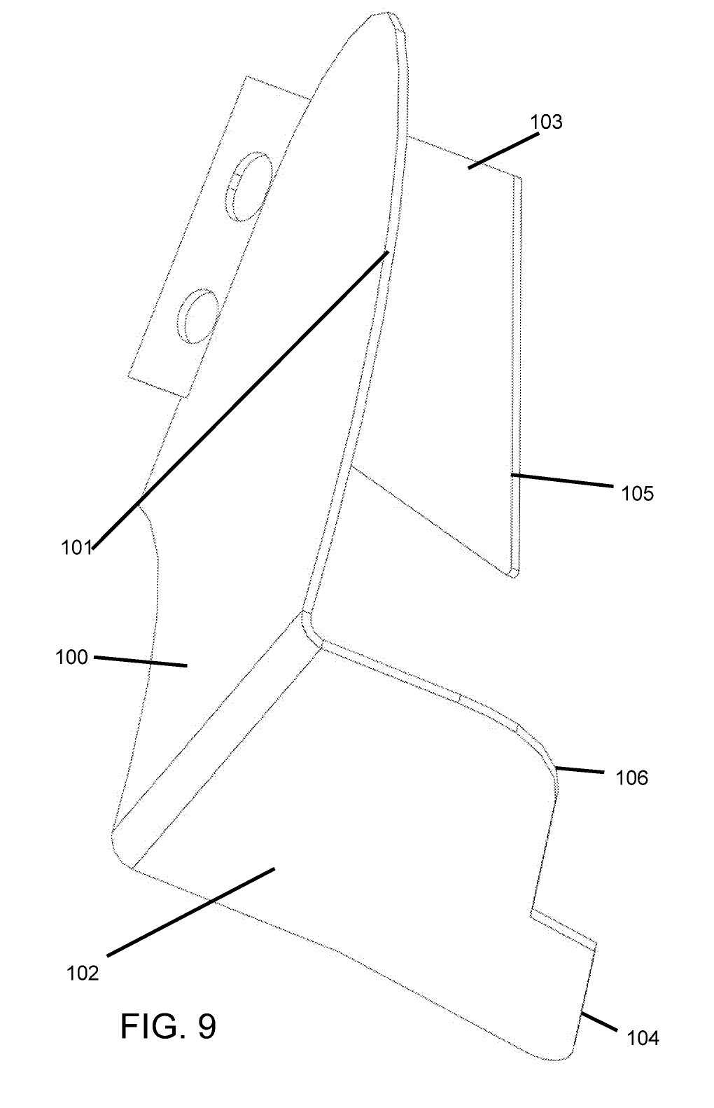

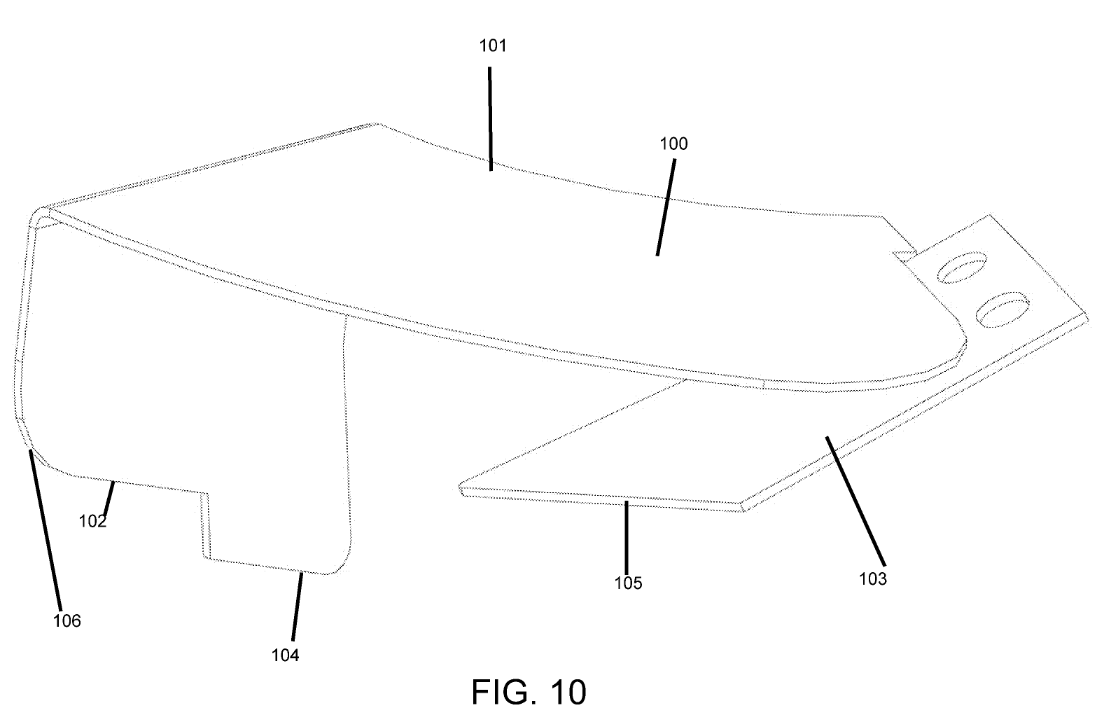

A wiper assembly 44 is mounted to be movable into a closed position (as in FIG. 2) or open position (as in FIG. 3). Referring to FIG. 3, a top perspective view of the sorter bowl with the wiper assembly in an open position, it is seen that the wiper assembly 44 carries a wiper 46 thereon, suitably a flexible plastic member. Referring to FIGS. 9 and 10, the wiper assembly comprises an elongate flick shield member 100, suitably curved along region 101 to fit within the curved profile of the bowl, with a forward face flange portion 102 extending downwardly at a right angle, defining edge 104 which conforms to a shape profile of the surface of sorter wheel 36 in the region of the rhinestone receiving holes 42, so as to ride thereon, and including curved portion 106 that corresponds to the interior edge of the bowl. A wiper 103 includes a substantially straight wiper edge portion 105 at a lower end thereof that rides over the area of the rhinestone receiving holes 42 on wheel 36. Referring to FIG. 7, the wiper arm and flick shield suitably ride on the top surface of the wheel 36 in at least regions 108 and the flick shield may also include further flange portions to ride on the upper face of region 110 and against a portion of the shoulder 50.

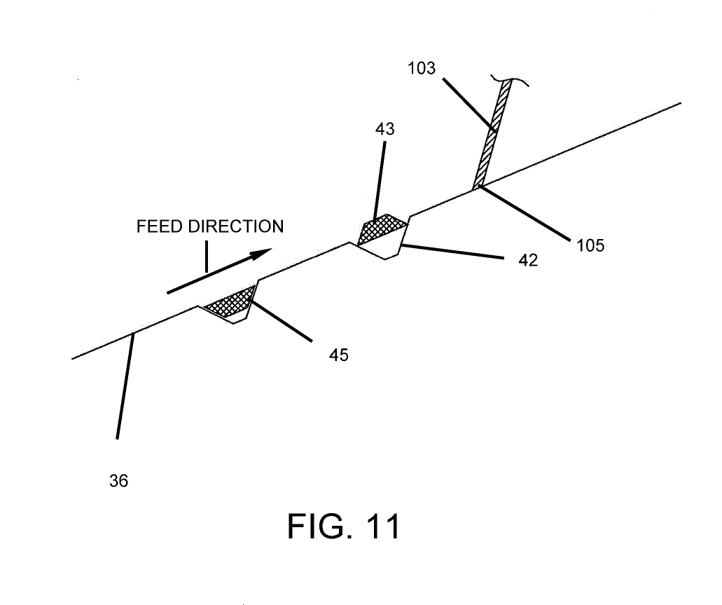

In operation, the sorter bowl is partially filled with a supply of rhinestones and the wheel rotates counterclockwise. Individual rhinestones will settle into holes as the wheel rotates. The plural rhinestone receiving holes 42 are of size and configuration such that when properly seated in a hole, the top surface of the rhinestone will be below the surface face of the sorter wheel adjacent the hole. However, if the rhinestone is not in the correct position (e.g. upside down), a portion of the rhinestone will be higher than the surface face of the sorter wheel. Thus, as the wheel rotates counterclockwise, the wiper arm portion 105 will contact and wipe any mis-positioned rhinestone 43 out of the hole as indicated in FIG. 11, but will not contact any properly positioned rhinestone 45, allowing the rhinestone to remain in the hole. The flick shield 100 prevents any rhinestones being removed by the wiper from flipping out of the bowl, the rhinestone instead hitting the interior surface of the flick shield and thereby falling back into the bowl.

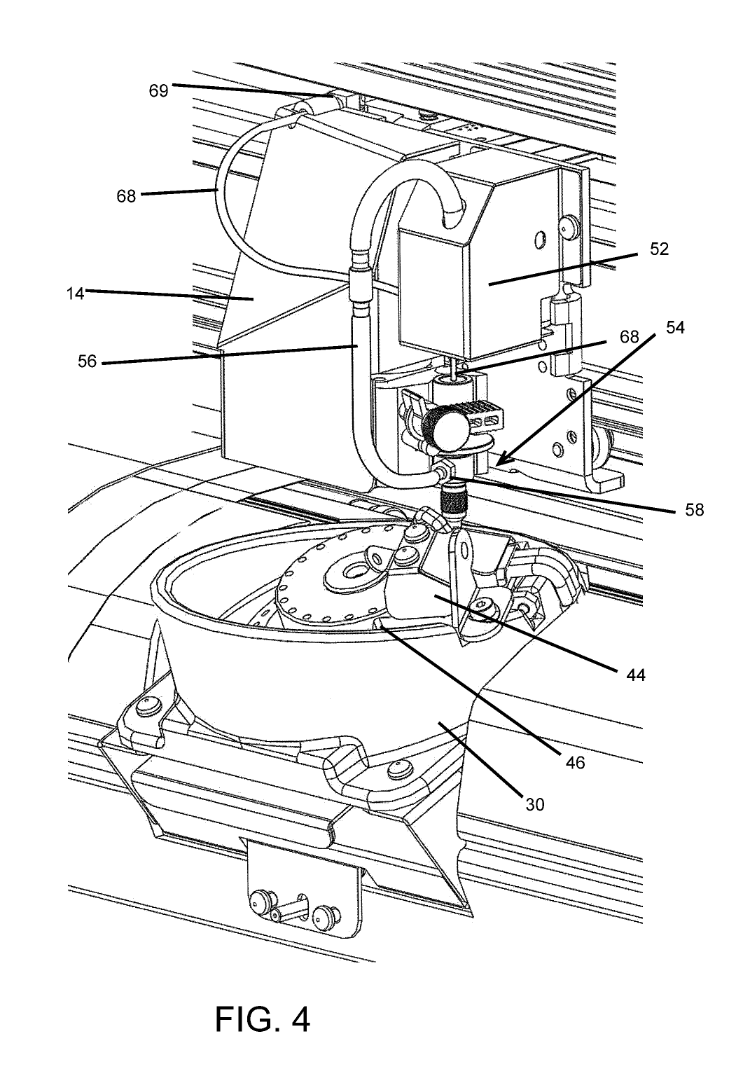

FIG. 4 is a perspective view of the movable pickup and placement head assembly 14 when at a position over the sorter bowl. The assembly 14 includes a vacuum pump 52 mounted thereon, supplying vacuum to a pickup tool 54, and mechanisms to raise and lower the pickup tool for pickup and placement of rhinestones. The vacuum is supplied to the pickup tool via vacuum hose 56. The vacuum pump is electrically powered and suitably provides 12 mmHg of suction. As discussed below, the vacuum pump is cycled to pickup pressure only when picking and placing rhinestones, so that the pump does not need to run all the time. A suitable pump in a preferred embodiment comprises an eccentric diaphragm pump manufactured by Schwarzer Precision GmbH of Essen, Germany, suitably a 4.5 V model SP 500.

An optical fiber 68 is received by sensor 69 and extends to the pickup tool 54.

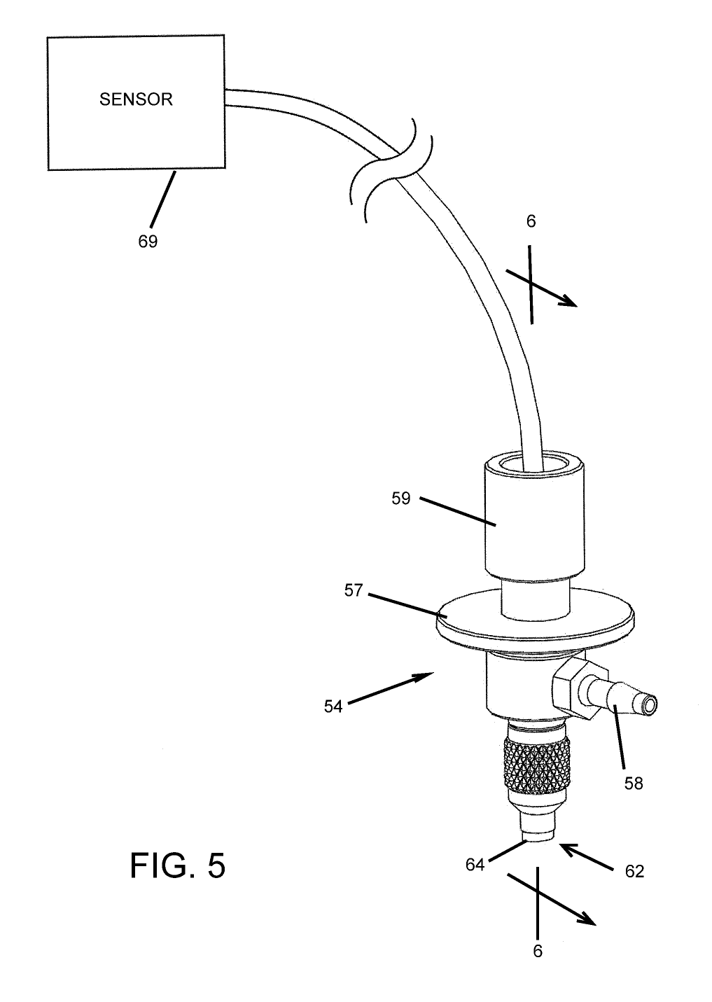

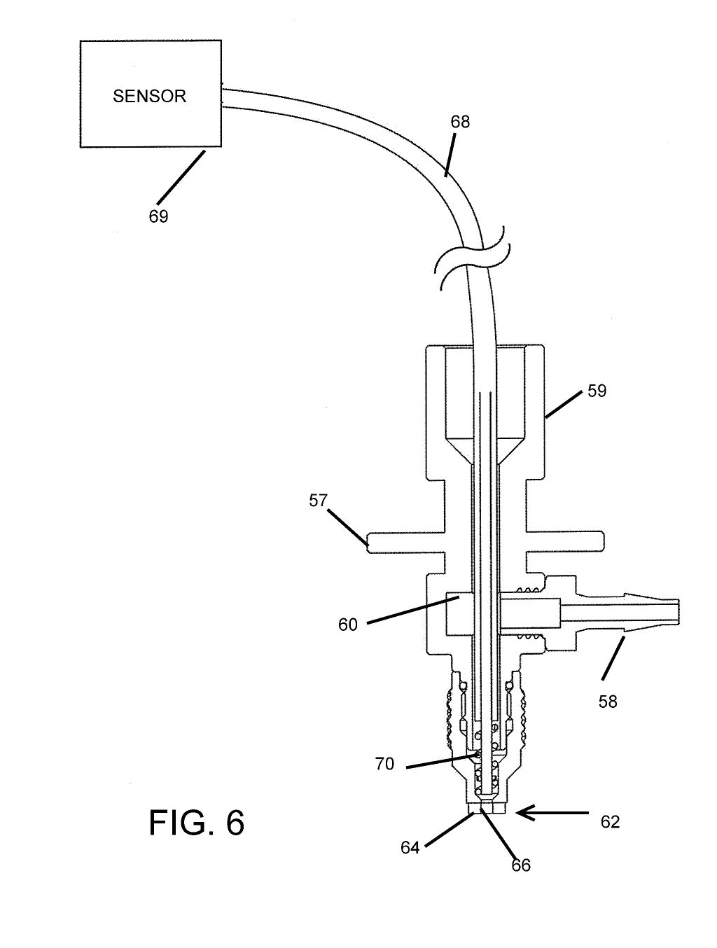

Considering FIG. 5, a perspective view of the pickup tool 54, and FIG. 6, a side sectional view of the pickup tool taken along line 6-6 of FIG. 5, the tool is elongate with a central flange 57 for removable mounting to the head assembly 14 (mounting discussed hereinbelow) and includes vacuum connector 58 to receive the vacuum hose 56. A cylindrical collar member 59 defines the upper extent of the tool body, and a connector 58 communicates with interior vacuum chamber 60 inside the pickup tool, wherein chamber 60 extends downward through the body of the pickup tool via a central tubular portion to supply vacuum to a tip end 62. Mounted at the tip end of the pickup tool is a toroidal shape gasket 64, which has a central opening 66 communicative with the vacuum chamber 60. Gasket 64 is suitably a visco-elastic urethane with self-healing and adhesive properties, being a 0.060 inch thick 70 durometer ‘doughnut shape’ Sorbothane brand material, manufactured by Sorbothane, Inc., of Kent, Ohio. Suitably the exterior presented face of the gasket is flat, although it may be shaped in other configurations to conform to a profile or shape characteristics of a rhinestone being picked up.

The toroidal/doughnut shape of the gasket provides a central opening 66 which communicates with the vacuum chamber 60. In operation, the gasket 64 acts as a gasket when picking up a rhinestone to provide sealing such that the vacuum holds the rhinestone to the tip. Further, the gasket can include adhesive properties to assist in the rhinestone staying in position at the tip while the vacuum is operational.

Optical fiber 68 is positioned within the central channel of the pickup tool, with an end near the end of the pickup tool. A circumferential spring 70 receives the optical fiber at its end for assisting in maintaining the position of the fiber while not blocking vacuum supply through the passage to the tip. The opposite end of fiber 68 is communicated to the optical sensor 69.

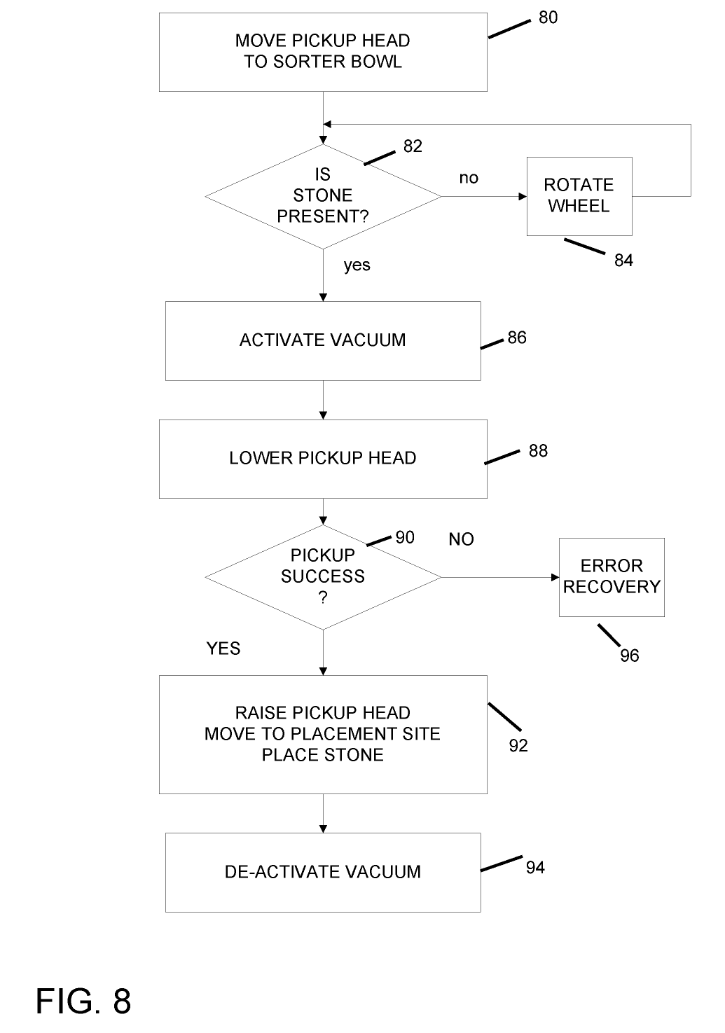

Considering FIG. 7, a side sectional view of the pickup tool in position above sorter wheel 36 preparatory to picking a rhinestone, and FIG. 8, a flowchart of the pickup process, in operation, in step 80, the pickup head is moved to the sorter bowl for picking up a rhinestone. Wheel 36 has been rotated such that a rhinestone receiving hole 42 is directly below the pickup tool. The tool is lowered in the direction of arrow 72 to move toward the rhinestone. A light source, suitably a LED, mounts to the placement head assembly, being directed to shine below the placement head at a rhinestone pickup and placement location as the head is moved, providing light beam 74 shining onto the pickup area and light is transferred by optical fiber 68 to a detector which interprets the light to determine whether a rhinestone is present in this particular receiving hole (decision block 82). The situations of rhinestones being present or not present result in a different light characteristics as sensed by the detector. If no rhinestone is present, the sorter wheel is rotated to position a next hole beneath the pickup tool (block 84), sensing and rotating continuing until a rhinestone is determined to be in the hole. Then, the vacuum pump is activated (block 86) and the pickup tool is lowered toward the rhinestone (block 88), whereupon the operation of the vacuum and gasket will temporarily seat the rhinestone to the gasket. When the rhinestone is seated, the light profile detected through the optical fiber will change, as the light source is now blocked by the rhinestone, which results in a determination that the rhinestone has been successfully seated (decision block 90). The tool is now raised in the Z-axis direction of arrow 76 to enable movement of the placement head in the Y-axis direction 16 for positioning over the transfer sheet at a desired location. Once in position over the transfer sheet, the tool is lowered to press the rhinestone to the transfer sheet and adhesive interaction between the rhinestone and transfer sheet will adhere the rhinestone to the sheet (block 92). Vacuum is stopped (by turning off the vacuum pump) so that the rhinestone is released from the pickup tool (block 94) and the tool is moved upwardly in the Z-axis to enable movement back to one of the sorter bowls to pick up a subsequent rhinestone. At decision block 90, if the pickup was not successful, error recovery processing 96 is performed to attempt to generate a successful pickup.

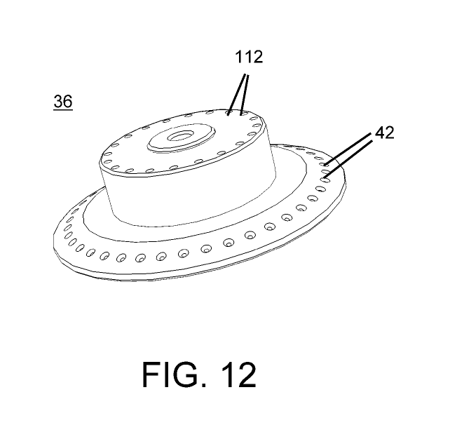

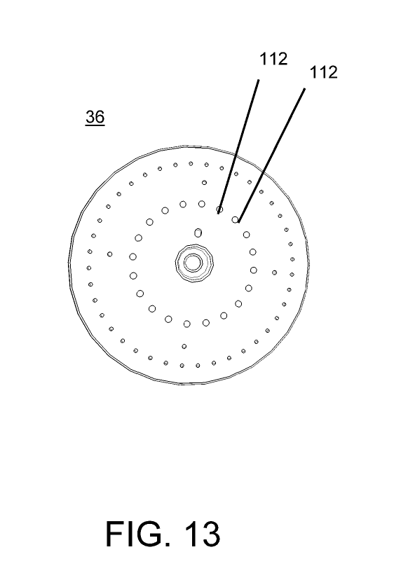

FIGS. 12 and 13 are front perspective view and rear views of an exemplary sorter wheels, wherein different wheels may be provided with different sized rhinestone receiving holes 42 to function with different sizes of rhinestones. The wheel is provided with an encoding such that the device senses the particular wheel configuration, to allow operational changes, for example depending on the rhinestone size being currently processed. Suitable encoding is provided by holes 112 that extend through the body of the wheel, such that an optical source/detector combination senses the configuration of holes to identify the wheel type. In the particular embodiment, a light source is provided at the top of the wheel (in assembly 44) to shine through the holes 112 for sensing by a detector mounted below the wheel. Any particular wheel would typically have fewer holes than the number illustrated in FIGS. 12 and 13 to implement a binary encoding system for plural wheels.

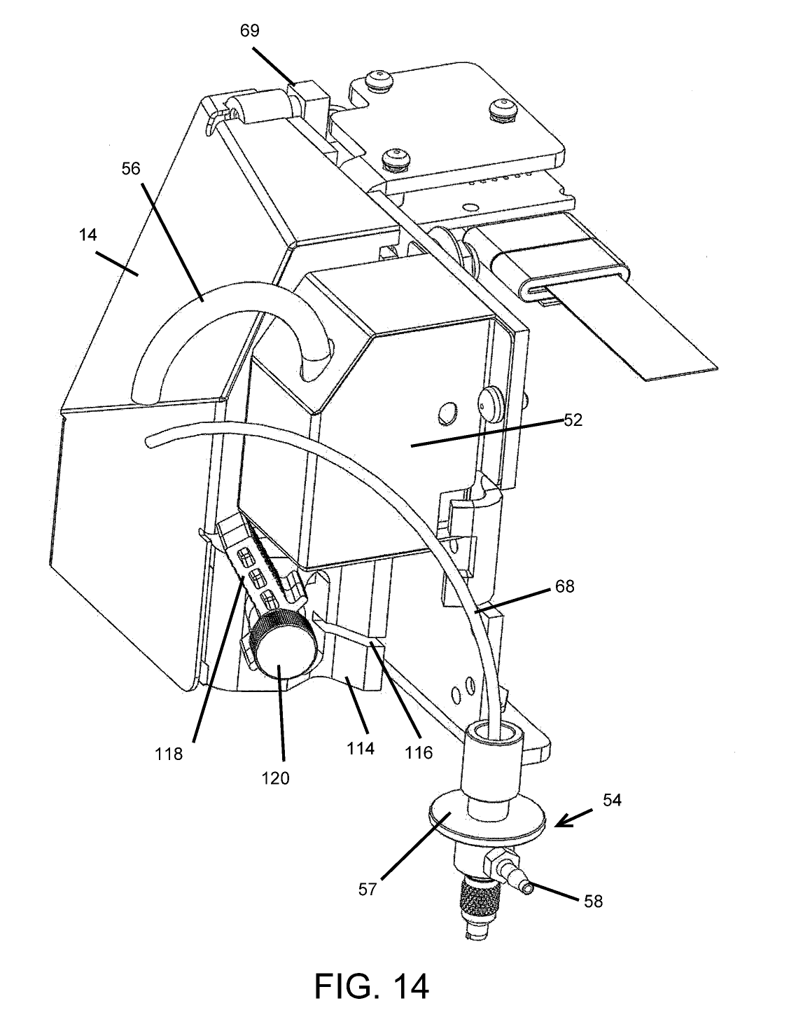

The pickup tool 54 is adapted to be removed from the placement device for replacement. With reference to FIGS. 14-16, the manner of installing a replacement pickup tool is described.

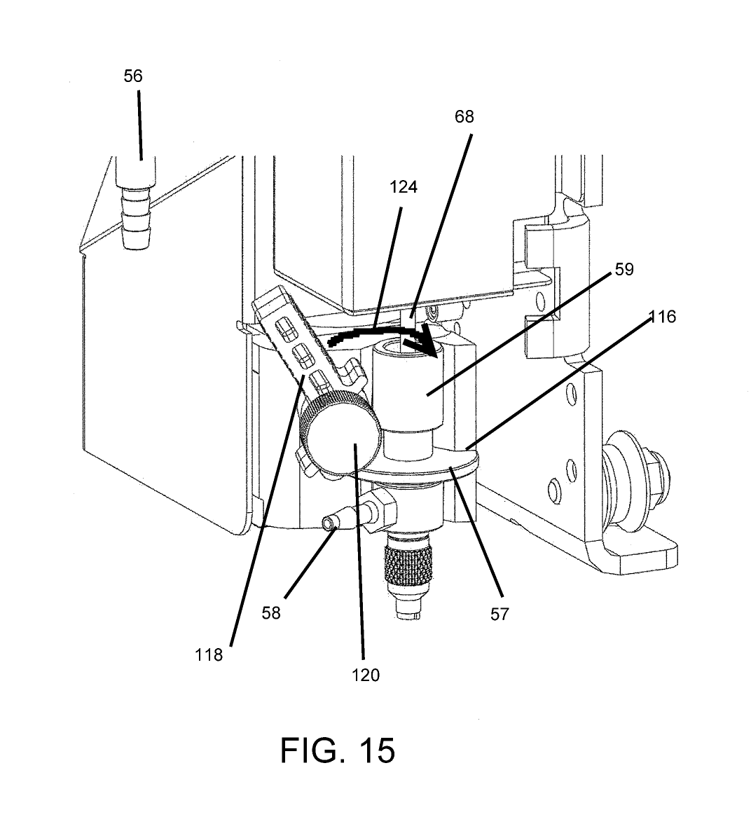

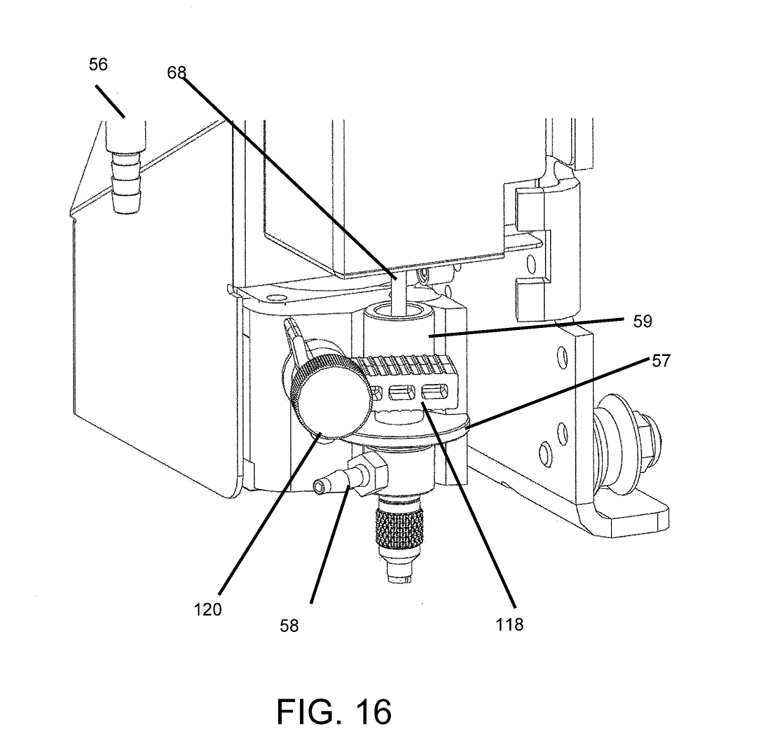

FIG. 14 is a perspective view of the pickup head assembly tool mounting, with the tool mount in an unlocked position to receive the pickup tool therein. The tool mount comprises a tool receiving member 114 mounted to the movable placement head 14 to move therewith. A receiving slot 116 extends laterally into the body of the member 114, of depth and height to receive flange 57 of the pickup tool therein. A rotationally mounted clamp 118 is positioned on the member 114, with thumbscrew 120 operative to tighten or loosen the clamp such that it is secured or free for rotation as discussed below. To mount the tool 54 to the head 14, the tool is moved in the direction of arrow 122 toward the receiving member 114 so as to align the flange 57 with the slot 116. The tool 54 is pushed inwardly in the direction of arrow 122 until the tool is seated fully against member 114. Then, with reference to FIG. 15, the clamp 118 is rotated in the direction of arrow 124 so as to swing downwardly to the position indicated in FIG. 16, whereby the inner face of clamp 118 abuts the face of collar 59. Thumbscrew 120 is tightened to secure the clamp in position, with the configuration of the member 114, the shape and diameter of collar 59 and the position of clamp 118 resulting in the tool being secured in position. Optical fiber cable 68 is then inserted into the sensor 69, and vacuum supply hose 56 is attached to vacuum connector 58. For removal of the pickup tool, the operation order is reversed. In this manner, the pickup head can be replaced as it wears for overall long operation life of the rhinestone placement device.

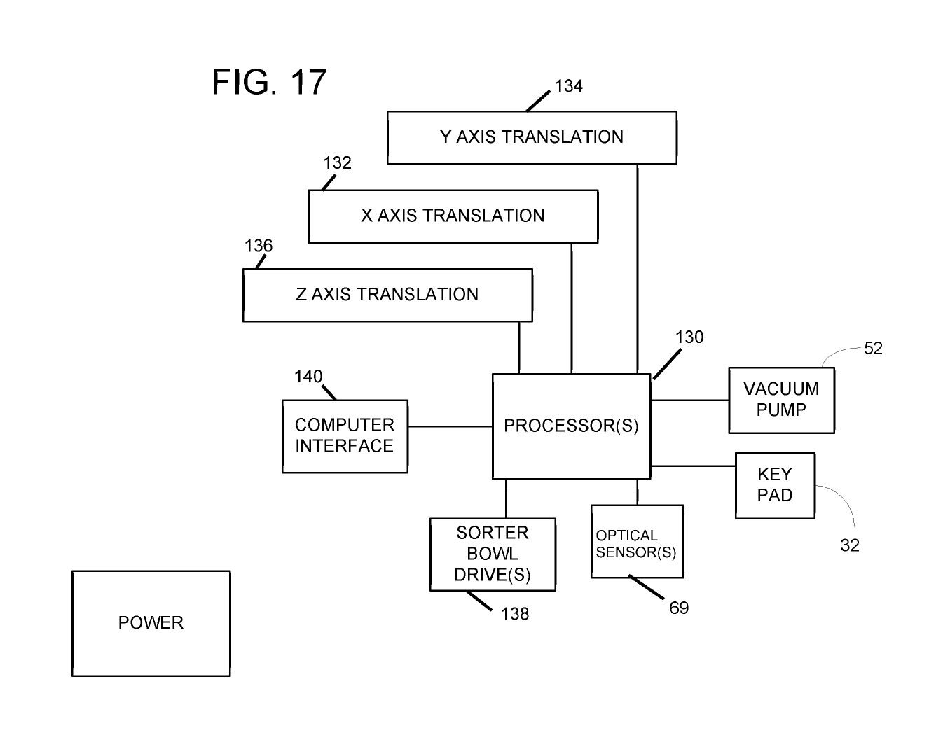

FIG. 17 is a block diagram of the operational system for the rhinestone placement device. Operation of the device is accomplished under control of processor(s) 130, which interfaces with X-axis translation mechanism 132 (the driving motors for controlling movement of the transfer sheet by operation of the drive wheels for the pinch wheels, Y-axis translation 134, which operates the drive motors for moving the belt drive mechanism that translates placement head 14 in the Y-axis, and Z-axis translation 136, which effects the up-down motion of the pickup tool. The processor, which may comprise plural processors directing different functions, also governs operation of the vacuum pump 52, and sorter bowl drive mechanisms 138 which rotates the sorting wheels. The processor further receives input from optical sensors 69 for detection of rhinestone pickup status (and other sensors employed to detect the sorter wheels and other device operation, for example) keypad 32 for user operational control. A computer interface 140 enables communication with an external computer for receiving instructions for direction of the rhinestone pickup and placement by design software, enabling users to define and effect rhinestone placement patterns. Feedback such as error conditions are also reported through the computer interface to allow the design software to interact with a user to deal with error conditions.

In accordance with the above described system and method, an improved rhinestone placement device is provided. The pickup tool with combination vacuum and pickup gasket enables improved rhinestone pickup. The vacuum supply is provided on the moving pickup head, resulting in more compact and efficient operation. The transfer sheet drive and system configuration enables unlimited length transfer sheets to be processed, such that any length of transfer sheet can be processed. The term rhinestone employed herein can also refer to other decorative stones or crystals intended for decorative placement on articles.

While a preferred embodiment of the present invention has been shown and described, it will be apparent to those skilled in the art that many changes and modifications may be made without departing from the invention in its broader aspects. The appended claims are therefore intended to cover all such changes and modifications as fall within the true spirit and scope of the invention.

What is claimed is:

1. A pickup tool for a rhinestone placement device, comprising:
a pickup tip portion;
a vacuum channel for providing vacuum to the pickup tip; and
a gasket mounted to the pickup tip for placement against a rhinestone to be picked up by the pickup tool.

2. The pickup tool according to claim 1, wherein said gasket has adhesive properties.

3. The pickup tool according to claim 1, wherein said gasket comprises a visco-elastic urethane.

4. The pickup tool according to claim 1 wherein said gasket comprises a 70 durometer hardness material.

5. The pickup tool according to claim 1 wherein said gasket comprises a 0.060 inch thick material.

6. The pickup tool according to claim 1 wherein said gasket comprises a central opening for passage of vacuum therethrough from the vacuum channel.

7. The pickup tool according to claim 1, further comprising an optical sensor for sensing status of rhinestone pickup by the pickup tip.

8. The pickup tool according to claim 7 wherein said gasket comprises a central opening for passage of vacuum therethrough from the vacuum channel and for sensing of rhinestone pickup by said optical sensor therethrough.

9. A rhinestone placement device, comprising:
a translation mechanism for translating a rhinestone receiving web along an X-axis;
a rhinestone pickup head translatable in a Y-axis having a vacuum supply mounted thereon and a rhinestone pickup tool employing vacuum from said vacuum supply for holding a picked up rhinestone to the pickup tool; and
a pickup actuator for moving said pickup tool in a Z-axis to translate said pickup tool to pick up a rhinestone from a supply position.

10. The device according to claim 9, wherein said rhinestone pickup tool comprises:
a pickup tip portion;
a vacuum channel for providing vacuum from said vacuum supply to said pickup tip portion; and
a gasket mounted to the pickup tip for placement against a rhinestone to be picked up by the pickup tool.

11. The device according to claim 10, wherein said gasket has adhesive properties.

12. The device according to claim 10, wherein said gasket comprises a visco-elastic urethane.

13. The device according to claim 10 wherein said gasket comprises a 70 durometer hardness material.

14. The device according to claim 10 wherein said gasket comprises a 0.060 inch thick material.

15. The device according to claim 10 wherein said gasket comprises a central opening for passage of vacuum therethrough from the vacuum channel.

16. The device according to claim 9, further comprising an optical sensor for sensing status of rhinestone pickup by the pickup tip.

17. The device according to claim 16 wherein said gasket comprises a central opening for passage of vacuum therethrough from the vacuum channel and for sensing of rhinestone pickup by said optical sensor therethrough.

18. A method of providing a rhinestone placement system comprising:
providing a movable rhinestone pickup head having a self-contained vacuum supply therein;
providing a pickup tool on said pickup head to pick up a rhinestone from a rhinestone supply position;
moving said pickup head and pickup tool to a rhinestone pickup position;
effecting temporary holding of said rhinestone to said pickup tool by operation of said self-contained vacuum supply and a pickup gasket member; and
moving said pickup head with said rhinestone held by said pickup tool to a placement position; and
releasing said temporary holding of said rhinestone at the placement position.

19. The method according to claim 18, wherein said providing a pickup tool comprises:
providing a pickup tip portion;
providing a vacuum from said vacuum supply to said pickup tip portion; and
providing a gasket mounted to the pickup tip for placement against a rhinestone to be picked up by the pickup tool.

20. The method according to claim 15, wherein said gasket comprises a central opening for passage of vacuum therethrough from the vacuum channel and further comprising providing vacuum via said central opening for pickup of a rhinestone and further comprising providing optical sensing of status of rhinestone pickup through said central opening.
